(19) United States
(12) Patent Application Publication
(10) Pub. No.: US 2013/0068021 A1
(43) Pub. Date: Mar. 21, 2013

(54) INERTIAL SENSOR

(71) Applicants: Heung Woo PARK, Gyunggi-do (KR); Jun LIM, Gyunggi-do (KR)

(72) Inventors: Heung Woo PARK, Gyunggi-do (KR); Jun LIM, Gyunggi-do (KR)

(73) Assignee: SAMSUNG ELECTRO-MECHANICS CO., LTD., Gyunggi-do (KR)

(21) Appl. No.: 13/332,284

(22) Filed: Dec. 20, 2011

(30) Foreign Application Priority Data
Sep. 21, 2011 (KR) 10-2011-0095357

(51) Int. Cl. G01P 15/08

(52) U.S. Cl. 73/514.16

(57) ABSTRACT

Disclosed herein is an inertial sensor including: a sensor part including a driving body displaceably mounted on a flexible substrate part, a driving unit moving the driving body, and a displacement detection unit detecting a displacement of the driving body, wherein the inertial sensor includes an application specific integrated circuit (ASIC) including the sensor part coupled thereto; a printed circuit board including the ASIC coupled thereto and electrically connected to the sensor part and the ASIC by a wire; and a cap covering the sensor part and the ASIC and coupled to the printed circuit board, whereby the driving body and the flexing substrate part is protected and an interval between the driving body and the flexible substrate part is optimized to obtain efficient driving characteristics and a Q factor and improve a freedom of design in a space use.

### CROSS REFERENCE TO RELATED APPLICATION

This application claims the benefit of Korean Patent Application No. 10-2011-0095357, filed on Sep. 21, 2011, entitled “Inertial Sensor,” which is hereby incorporated by reference in its entirety into this application.

### BACKGROUND OF THE INVENTION

1. Technical Field

The present invention relates to an inertial sensor.

2. Description of the Related Art

Generally, an inertial sensor measuring acceleration and/or angular velocity has been widely used while being mounted in a motion remote controller for screen conversion of a mobile phone, a game, and a digital TV, a remote controller of a game machine, and a sensor module for sensing hand shaking and sensing a position and an angle of motion, or the like.

In addition, the inertial sensor senses motion as acceleration or angular velocity and converts the sensed information into an electrical signal. Therefore, when a device is operated by using a user's motion as an input, it is possible to implement a motion interface. In addition, the inertial sensor has been widely used in a navigation and control sensor of an airplane and a vehicle, in addition to a motion sensor such as home appliances, or the like.

Further, as the inertial sensor is used for a portable PDA, a digital camera, or a mobile phone, or the like, a need exists for a technology capable of implementing a compact and light inertial sensor with various functions. As a result, a development of a micro-sensor module has been demanded.

In addition, an inexpensive and micro-inertial sensor for a personal portable product has mainly used a capacitive type and a type using a piezoelectric element. A driving unit of the inertial sensor may be sorted into a piezo-electric type and a capacitive type and a sensing unit thereof may be sorted into a piezo-electric type, a capacitive type, and a piezoresistive type.

Further, in the case of an inertial sensor using a piezoelectric element among the inertial sensors according to the prior art, a silicon structure includes a driving body, a flexible substrate part, and a support body, wherein the flexible substrate part is provided with a vibrating electrode and a sensing electrode, current is applied to the vibrating electrode to thereby drive the driving body, and the sensing electrode senses displacement of the driving body due to the driving of the driving body.

In addition, the inertial sensor using a piezoelectric element does not require vacuum packaging and may be implemented through atmospheric pressure packaging in contrast with the capacitive type inertial sensor. Therefore, after a silicon structure element is mounted on a lead frame, an epoxy molding compound (EMC) molding process filling the surrounding of the element with epoxy is performed. However, in order to perform the EMC molding process, an upper cap for protecting the silicon structure element should be included. In addition, a difference occurs in positions of the silicon structure after the EMC molding process, and a high process temperature is required in order to perform the EMC molding process.

Further, a volume of a cavity for driving of the driving body is very important in determining driving characteristics. However, an optimal design for driving of the driving body is not implemented, such that a sensor design according to damping or high speed driving of the driving body may not be implemented.

### SUMMARY OF THE INVENTION

The present invention has been made in an effort to provide an inertial sensor including a cap for packaging the inertial sensor and having improved freedom of design while obtaining efficient driving characteristics and a Q factor, by optimizing an interval between a driving body and a flexible substrate part while protecting the inertial sensor.

According to a preferred embodiment of the present invention, there is provided an inertial sensor including: a sensor part including a driving body, a flexible substrate part displaceably supporting the driving body, a support body supporting the flexible substrate part so that the driving body is freely movable in a state in which it is floated, and a lower cap covering a lower portion of the driving body and coupled to the support body; an application specific integrated circuit (ASIC) including the sensor part coupled thereto; a printed circuit board including the ASIC coupled thereto and electrically connected to the sensor part and the ASIC by a wire; and a cap covering the sensor part and the ASIC and coupled to the printed circuit board.

A cavity may be formed between the cap and the flexible substrate part and a height of the cavity that is a distance between the cap and the flexible substrate part may be 100 to 150 μm.

The cap may be made of metal and the cap may be coupled to the printed circuit board by bonding.

A cavity may be formed between the driving body and the lower cap and a height of the cavity that is a distance between a lower end of the driving body and the lower cap may be 100 to 150 μm.

The lower cap may be made of silicon or Pyrex glass.

The lower cap may be thinned and may then be coupled to the lower portion of the support body.

The lower cap may be coupled to the lower portion of the support body by wafer level bonding or polymer bonding.

The flexible substrate part of the sensor part and the printed circuit board may be electrically connected to each other by the wire and the ASIC and the printed circuit board may be electrically connected to each other by the wire.

### BRIEF DESCRIPTION OF THE DRAWINGS

The patent or application file contains at least one drawing executed in color. Copies of this patent or patent application publication with color drawing(s) will be provided by the U.S. Patent and Trademark Office upon request and payment of the necessary fee.

FIG. 1 is a schematic cross-sectional view of an inertial sensor according to a preferred embodiment of the present invention.

FIG. 2 is a graph showing performance measurement data of X, Y, and Z axes in the inertial sensor according to the preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, an inertial sensor according to preferred embodiments of the present invention will be described with reference to the accompanying drawings.

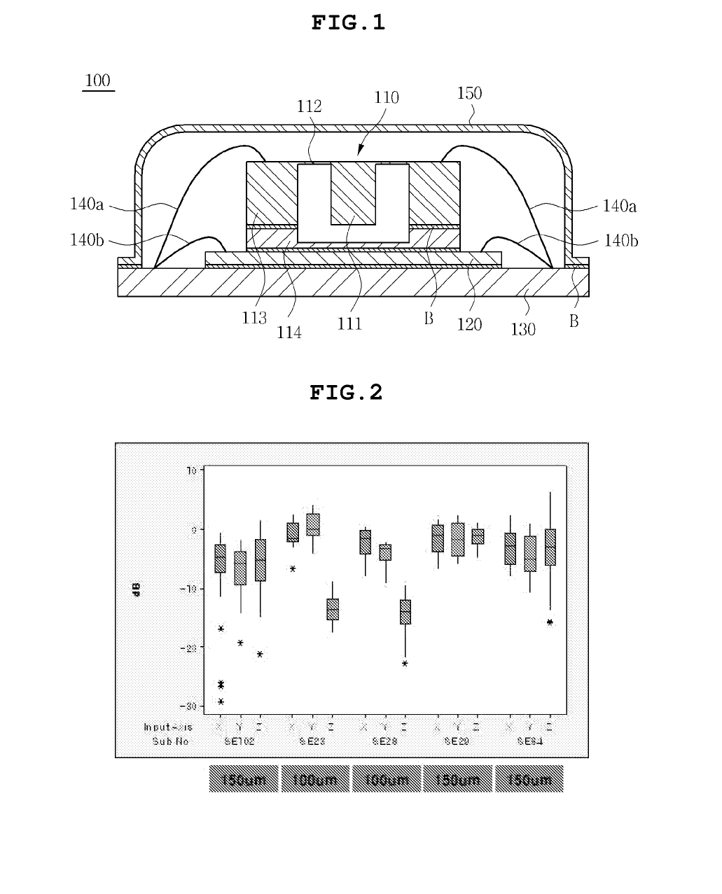

FIG. 1 is a schematic cross-sectional view of an inertial sensor according to a preferred embodiment of the present invention. As shown, the inertial sensor 100 is configured to include a sensor part 110, an application specific integrated circuit (ASIC) 120, a printed circuit board 130, wires 140a and 140b, and a cap 150.

Here, the sensor part 110 includes a driving body 111, a flexible substrate part 112, support bodies 113, and a lower cap 114.

More specifically, the flexible substrate part 112 includes a flexible substrate, a piezoelectric element (PZT), and an electrode, wherein the flexible substrate is formed of a silicon or silicon on insulator (SOI) substrate and includes driving electrode (not shown) and a sensing electrode (not shown) formed by depositing the piezoelectric element and the electrode thereon. Further, the driving body 111 is disposed to move downwardly toward the flexible substrate part 112 and the driving body 111 moves according to the application of voltage to the driving electrode on the flexible substrate part 112.

In addition, the support body 113 supports the driving body 111 and the flexible substrate part 112 and supports the driving body so as to freely move in a floating state.

Further, the lower cap 114 is to support the sensor part to the ASIC 120 while covering the driving body 111. Further, the lower cap 114 may be made of silicon that is the same material as the driving body 111 and the support body 113 or may be made of Pyrex glass, etc., having a similar thermal expansion coefficient. However, it is preferable that the lower cap 114 is made of silicon that is the same material as the driving body 111 and the support body 113 in consideration of workability and process capability.

Further, the lower cap 114 may be formed to have a thickness of 100 to 200 μm, in consideration of forming the lower cap 114 so as to be easily machined and handled. In more detail, when the lower cap 114 is configured by a substrate of 4 inches, the thickness of the lower cap 114 may be about 100 μm, when the lower cap is configured by a substrate of 6 to 8 inches, the thickness of the lower cap 114 may be 120 to 150 μm, and when the lower cap 114 is implemented by a substrate of 12 inches, the thickness of the lower cap may be 150 to 200 μm.

As the implementation therefor, the lower cap 114 may be formed by bonding thin capping substrates to each of the support bodies 113, thick capping substrates to each of the support bodies 113, and then, thinly polishing them. Further, the above-mentioned two methods may be performed. However, as the driving body 111 is supported to the thin flexible substrate part 112, when the lower cap is bonded to the flexible substrate part and the support body and the entire configuration is then polished, a thin flexible substrate part may be damaged and mass production may be reduced when the polishing process is limited so as to lower the risk of damage. Therefore, it is preferable to form the lower cap 114 by thinning the packing substrate and then, bonding the packing substrate to the support body 113.

In addition, it is preferable to bond the lower cap 114 to the support body 113 by a wafer level bonding method in consideration of the process capability and the economical performance, which may be performed at a low-temperature process of 300° C. or less so as to maintain characteristics of a piezoelectric thin film element. More specifically, the lower cap 114 is coupled to the support body 113 by polymer bonding using a photoresist or epoxy. As a result, a bonding part B is formed.

The sensor part 110 is configured as described above, the lower cap 115 of the sensor part 110 is stacked on and coupled to the ASIC 120, and the ASIC 120 is stacked on and coupled to the printed circuit board 130. In addition, the flexible substrate part 112 of the sensor part 110 is electrically connected to the printed circuit board 130 by a wire 140a, and the ASIC 120 is electrically connected to the printed circuit board 130 by a wire 140b.

Through the above-mentioned configuration, sensing and driving signals of the sensor part 110 are directly transferred to the printed circuit board 130, and the ASIC 120 and the printed circuit board are electrically connected to each other, such that signals are exchanged and processed therebetween.

In addition, the cap 150 is coupled to the printed circuit board 130 simultaneously with covering the sensor part 110, the ASIC 120, and the wires 140a and 140b. The cap 150 may be coupled to the printed circuit board 130 by polymer bonding using epoxy. As a result, a bonding part B is formed. In addition, the cap 150 may be made of various materials. However, it is preferable that the cap is made of a metal in consideration of durability, moisture resistance, and the like.

In addition, in order to apply the inertial sensor according to the preferred embodiment of the present invention to a mobile terminal, the thickness of the sensor part 110 needs to be small. To this end, the sensor part 110 may be formed to have a thickness of 1.0 mm or less.

In addition, when the ASIC 120 is formed to be thicker by 500 μm in a vertical direction than the sensor part 110, the ASIC 120 is formed to be thicker by 250 μm in one direction, such that the process capability is good when performing the wire bonding and a short wire bonding may be performed while forming a high step.

Further, the insides of the cap 150 and the lower cap 114 are provided with cavities so as to improve device characteristics. Further, the driving characteristics of the driving body 111 is affected by a size of the cavity, that is, a distance between the flexible substrate part 112 and the cap 150, and a distance between a lower end of the driving body 111 and the lower cap 114.

In more detail, a volume of the cavity is very important in determining the driving characteristics. That is, when the volume of the cavity is small, the driving characteristics are affected by a damping effect and when a high Q factor is required, it is preferable to increase an interval between the flexible substrate part 112 and the cap and an interval between the driving body 111 and the lower cap. In addition, when the rapid driving is required, it is preferable to reduce the interval between the driving body 111 and the lower cap 114.

Preferably, a height of the cavity that is a distance between the flexible substrate part 112 and the cap 150 and a distance between the lower end of the driving body 111 and the lower cap 114 may be the same as each other, for example, 20 to 100 μm.

In addition, the cavity formed by the distance between the lower cap 114 and the driving body 111 may be formed by performing dry etch or wet etch on an opposite surface of the lower cap 114 and may be secured only by the thickness of the bonding part (B) without machining the lower cap. In this case, as the thickness of the sensor part 110 is thick, it is preferable to form the cavity by machining the opposite surface of the lower cap 114 for the driving body 111 so as to make the sensor part 110 small.

FIG. 2 is a graph showing performance measurement data of X, Y, and Z axes in the inertial sensor according to the preferred embodiment of the present invention. The shown graph is data indicating measurement results of an actual sample of which the performance for the X, Y, and Z axes are measured.

In more detail, when a gap with the cap for the driving body having a thickness of 500 μm is 150 μm or 100 μm, signal sizes dB for each driving is measured and the measured data is represented on a Y axis of the graph.

As shown, it can be confirmed that when the gap is 150 μm, the driving characteristics of the X, Y, and Z axes are formed so as to be similar to each other, but when the gap is 100 μm, the driving characteristic of the Z axis is more degraded than that of the X and Y axes. Therefore, in the inertial sensor having the driving body having the thickness of 500 μm, it can be confirmed that the gap with the cap is preferably 150 μm. Therefore, in the design conditions, it is preferable that the gap is formed at 100 μm or more and 150 μm or less.

In addition, when the size of the driving body is small, an air damping therefor may be reduced. Therefore, in the inertial sensor having the driving body having a thickness of 410 μm, it can be derived through the experimental data of FIG. 2 that the driving characteristics are not degraded even though the gap between the driving body and the cap may also be implemented at 100 μm.

As set forth above, the exemplary embodiments of the present invention can provide the inertial sensor including the cap for packaging the inertial sensor and having the improved freedom of design in a space use while obtaining the efficient driving characteristics and the Q factor, by optimizing the interval between the driving body and the flexible substrate part while protecting the inertial sensor.

Although the embodiment of the present invention has been disclosed for illustrative purposes, it will be appreciated that an inertial sensor according to the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An inertial sensor, comprising:
a sensor part including a driving body, a flexible substrate part displaceably supporting the driving body, a support body supporting the flexible substrate part so that the driving body is freely movable in a state in which it is floated, and a lower cap covering a lower portion of the driving body and coupled to the support body;
an application specific integrated circuit (ASIC) including the sensor part coupled thereto;
a printed circuit board including the ASIC coupled thereto and electrically connected to the sensor part and the ASIC by a wire; and
a cap covering the sensor part and the ASIC and coupled to the printed circuit board.

2. The inertial sensor as set forth in claim 1, wherein a cavity is formed between the cap and the flexible substrate part and a height of the cavity that is a distance between the cap and the flexible substrate part is 100 to 150 μm.

3. The inertial sensor as set forth in claim 1, wherein the cap is made of metal and the cap is coupled to the printed circuit board by bonding.

4. The inertial sensor as set forth in claim 1, wherein a cavity is formed between the driving body and the lower cap and a height of the cavity that is a distance between a lower end of the driving body and the lower cap is 100 to 150 μm.

5. The inertial sensor as set forth in claim 1, wherein the lower cap is made of silicon or Pyrex glass.

6. The inertial sensor as set forth in claim 1, wherein the lower cap is thinned and is then coupled to the lower portion of the support body.

7. The inertial sensor as set forth in claim 1, wherein the lower cap is coupled to the lower portion of the support body by wafer level bonding or polymer bonding.

8. The inertial sensor as set forth in claim 1, wherein the flexible substrate part of the sensor part and the printed circuit board are electrically connected to each other by the wire and the ASIC and the printed circuit board are electrically connected to each other by the wire.
